(19) United States
(12) Patent Application Publication
(10) Pub. No.: US 2023/0358520 A1
(43) Pub. Date: Nov. 9, 2023

(54) POWDER TRICKLER

(71) Applicant: Modgunn Security ApS, Langå (DK)

(72) Inventor: Rex Brian Petersen, Langå (DK)

(73) Assignee: Modgunn Security ApS, Langå (DK)

(21) Appl. No.: 18/134,127

(22) Filed: Apr. 13, 2023

(30) Foreign Application Priority Data
May 4, 2022 (DK) PA 2022 00419

(51) Int. Cl. F42B 33/02; B65B 1/08; B65B 1/34

(52) U.S. Cl. CPC F42B 33/0285; F42B 33/0207; B65B 1/08; B65B 1/34

(57) ABSTRACT

A powder trickler has a housing, a hopper connected to the housing and defining a reservoir, a first dispensing element having a first inlet in communication with the reservoir and a first outlet, a second dispensing element having a second inlet in communication with the reservoir and a second outlet, a receptacle connected to the housing and configured to receive powder from the first outlet and from the second outlet, a scale connected to the receptacle and operable to generate a weight value of powder in the receptacle, a controller connected to the scale to receive a weight value and connected to the first and second dispensing elements and operable to operate the dispensing elements, and the second dispensing element being a vibratory feeder and the first dispensing element having a feeding facility other than a vibratory feeder.

### CROSS-REFERENCE TO RELATED APPLICATION

This application claims the benefit of Danish Patent Application Number PA 2022 00419 filed on May 4, 2022, entitled “Dispenser for powder,” which is hereby incorporated by reference in its entirety for all that is taught and disclosed therein.

### FIELD OF THE INVENTION

The present invention relates to firearms, and more particularly to a powder trickler that enables the delivery of a precise weight of powder using multiple techniques.

### BACKGROUND AND SUMMARY OF THE INVENTION

Reloading casings for firearms is well known as providing a user with the ability to produce firearm cartridges having customized characteristics. To ensure consistency of each reload, each charge of powder is weighed. A variety of weighing methods are known, including mechanical and electronic scales. Mechanically and electronically operated powder tricklers are also known. Although these are suitable for their intended task, they typically suffer from a tradeoff between accuracy and speed. Although powder tricklers having two dispensing speeds are known, which enable faster feeding of a large quantity of powder with less accuracy followed by slower feeding of a small quantity of powder with greater accuracy, either speed or accuracy are decreased depending on the technology employed to dispense the powder.

Therefore, a need exists for a new and improved powder trickler that enables the delivery of a precise weight of powder using multiple dispensing techniques. In this regard, the various embodiments of the present invention substantially fulfill at least some of these needs. In this respect, the powder trickler according to the present invention substantially departs from the conventional concepts and designs of the prior art, and in doing so provides an apparatus primarily developed for the purpose of enabling the delivery of a precise weight of powder using multiple dispensing techniques.

The present invention provides an improved powder trickler, and overcomes the above-mentioned disadvantages and drawbacks of the prior art. As such, the general purpose of the present invention, which will be described subsequently in greater detail, is to provide an improved powder trickler that has all the advantages of the prior art mentioned above.

To attain this, the preferred embodiment of the present invention essentially comprises a housing, a hopper connected to the housing and defining a reservoir, a first dispensing element having a first inlet in communication with the reservoir and a first outlet, a second dispensing element having a second inlet in communication with the reservoir and a second outlet, a receptacle connected to the housing and configured to receive powder from the first outlet and from the second outlet, a scale connected to the receptacle and operable to generate a weight value of powder in the receptacle, a controller connected to the scale to receive a weight value and connected to the first and second dispensing elements and operable to operate the dispensing elements, and the second dispensing element being a vibratory feeder and the first dispensing element having a feeding facility other than a vibratory feeder. There are, of course, additional features of the invention that will be described hereinafter and which will form the subject matter of the claims attached.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

FIG. 1 is a sectional view of the current embodiment of a powder trickler constructed in accordance with the principles of the present invention.

FIG. 2 is an exploded view of the powder trickler of FIG. 1.

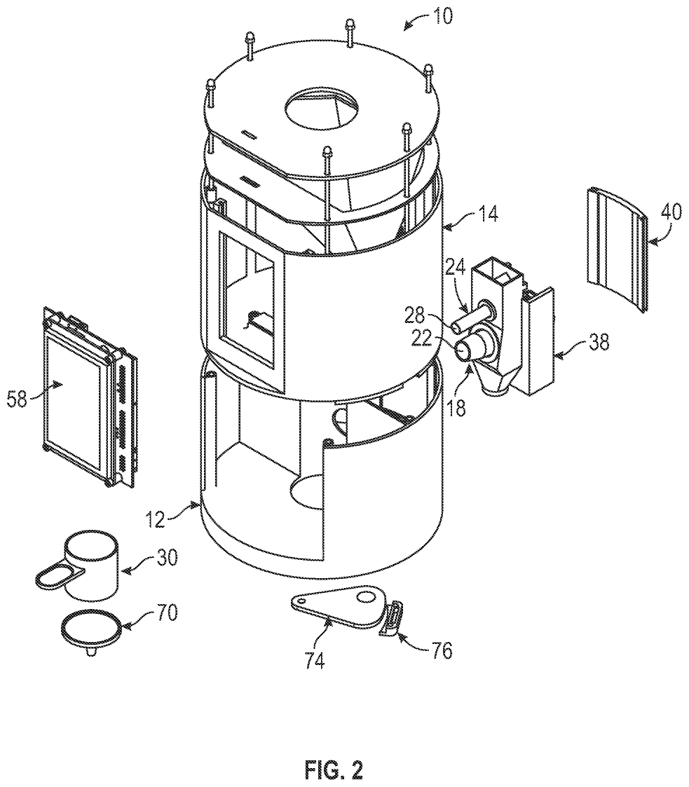

FIG. 3A is a flowchart of a method of dispensing a powder charge using the powder trickler of FIG. 1.

FIG. 3B is a flowchart of additional steps of the method of dispensing a powder charge of FIG. 3A.

The same reference numerals refer to the same parts throughout the various figures.

### DESCRIPTION OF THE CURRENT EMBODIMENT

An embodiment of the powder trickler of the present invention is shown and generally designated by the reference numeral 10.

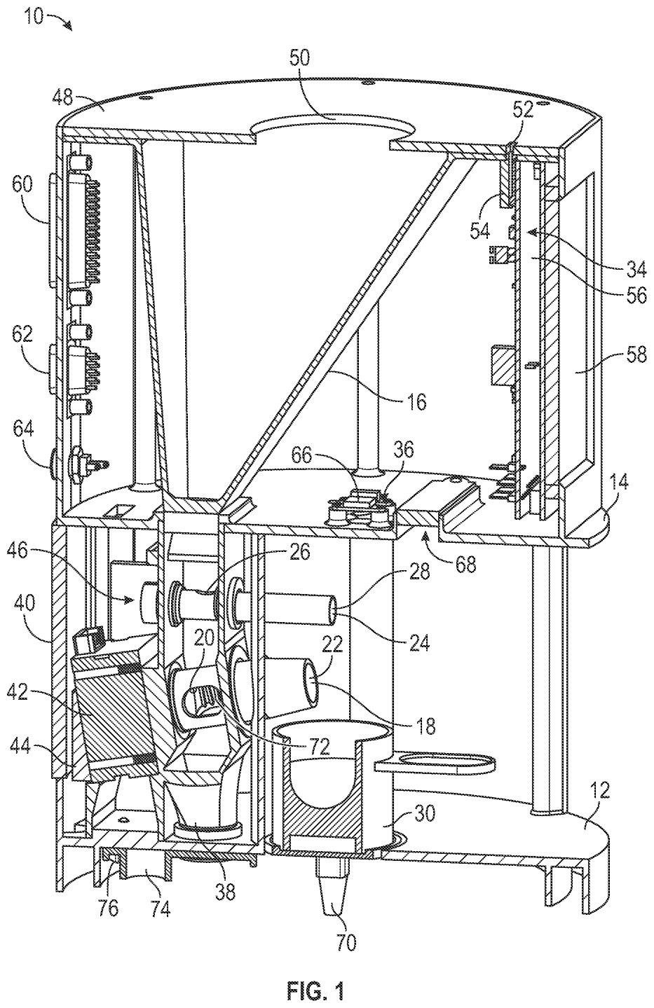

FIGS. 1 & 2 illustrate the improved powder trickler 10 of the present invention. More particularly, the powder trickler has a housing 12. A hopper 14 is connected to the housing and defines a reservoir 16. A first dispensing element 18 has a first inlet 20 in communication with the reservoir and a first outlet 22. The first dispensing element also includes an internal auger 72 connected to the first dispensing element so as to rotate as a single unit. In the current embodiment, the first dispensing element is made of aluminum, which is a lightweight material that does not produce sparks like steel or other ferrous materials do. A second dispensing element 24 has a second inlet 26 in communication with the reservoir and a second outlet 28. In the current embodiment, the second dispensing element is made of a plastic that prevents the formation of static electricity. A receptacle 30 in the form of a powder cup is placed on a platen 70 and is configured to receive powder from the first outlet and from the second outlet. A scale (not shown) is connected to the platen and operable to generate a weight value of powder in the receptacle. A controller 34 is connected to the scale to receive a weight value and is connected to the first and second dispensing elements and operable to operate the dispensing elements. In the current embodiment, the second dispensing element is a vibratory feeder, and the first dispensing element has a feeding facility other than a vibratory feeder. The first dispensing element is preferably a rotational feeding facility.

A sensor 36 is operably connected to the controller 34 juxtaposed with the receptacle 30 and is operable to detect a quantity of powder in the receptacle other than by weight. The sensor can include an optical emitter in the form of a laser unit 66 vertically located above the receptacle. The sensor can detect the presence and absence of the receptacle on the platen and can also detect the height of a quantity of powder in the receptacle while powder is being dispensed into the receptacle to prevent overfilling.

The controller 34 is operable to operate the first dispensing element 18 until a weight below a selected threshold weight is detected, and consequently to stop operating the first dispensing element and continue operating the second dispensing element 24 until the threshold weight is detected. The controller can be operable to begin operating the second dispensing element before stopping operation of the first dispensing element. The controller can be operable to operate the second dispensing element while operating the first dispensing element. The controller can be operable after stopping the first dispensing element to operate the second dispensing element at a reduced vibrational intensity. In the current embodiment, the second dispensing element is operable at a range of feed rates and at a range of vibrational intensities. The second dispensing element can be operable with periodic pulses of vibration with intervening periods without vibration. The controller receives the weight value from the scale during the intervening periods without vibration and, based on the weight value, determines if an additional pulse of vibration is required.

Experience has shown that gradual reduction of the vibration of the second dispensing element 24 once 85 to 95% of the target amount of powder has been delivered results in increased accuracy because of more controllable and regular flow of the powder during delivery of the final amounts of powder. Reduction of the vibration can include reducing the amplitude and/or changing the frequency of vibration. Experiments have also shown that a very uniform flow of powder is produced if the second dispensing element slopes upwards, preferably by more than 10°. Furthermore, a tube sloping upwards also prevents powder located at/on the edge of the second outlet 28 from falling out after the target weight value has been reached. Thus, an upwardly sloping tube reduces the number of charges that must be redone or discarded. The accuracy of a charge dispensed by the powder trickier 10 is typically 0.02 grain (0.00123 g).

It should be appreciated that the housing 12 is generally cylindrical in shape. The housing receives a motor house 38 that contains the first dispensing element 18 and second dispensing element 24. The motor house also includes a motor window 40. In the current embodiment, the first dispensing element includes a stepper motor 42 received by a stepper motor spacer 44. The stepper motor rotates the first dispensing element when the stepper motor is active to dispense powder from the first outlet 22. The second dispensing element includes a vibrating motor 46 that causes the second dispensing element to vibrate when the vibrating motor is active to dispense powder from the second outlet 28. The vibrating motor can be operated to vibrate the second dispensing element at varying intensities. The housing can also receive temperature and/or relative humidity measuring equipment (not shown).

The hopper 14 is covered by a removable hopper lid 48 that defines an aperture 50 in communication with the reservoir 16. The hopper lid also defines a slot 52. The slot enables a microSD card to be inserted into a microSD card port 54 on a printed circuit board (PCB) 56. The microSD card can enable the programming of the controller to be updated and can be used to store operational parameters and logs. The microSD card also functions as an ingress barrier to prevent powder from contacting the controller and other electronics. The controller 34 includes the PCB and a display 58. The display is preferably a touchscreen in the current embodiment, thereby making the display capable of receiving input. The controller is connected to an expansion port 60, a scale port 62 connected to the scale, and a power supply plug 64. The controller is also connected to the sensor 36, which includes the laser unit 66 and to a RGBW LED panel 68. The scale includes a platen 70. A powder exit slider 74 rides on a slider aligner 76. The powder exit slider can be moved to enable unused powder to be removed from the reservoir 16 and motor house 38.

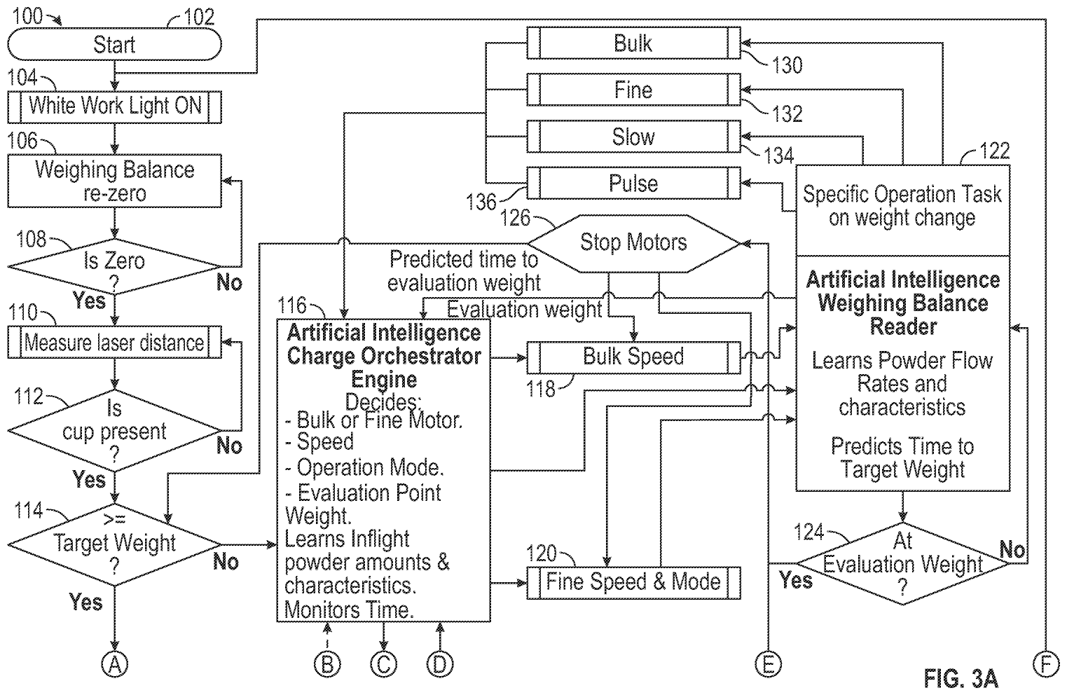

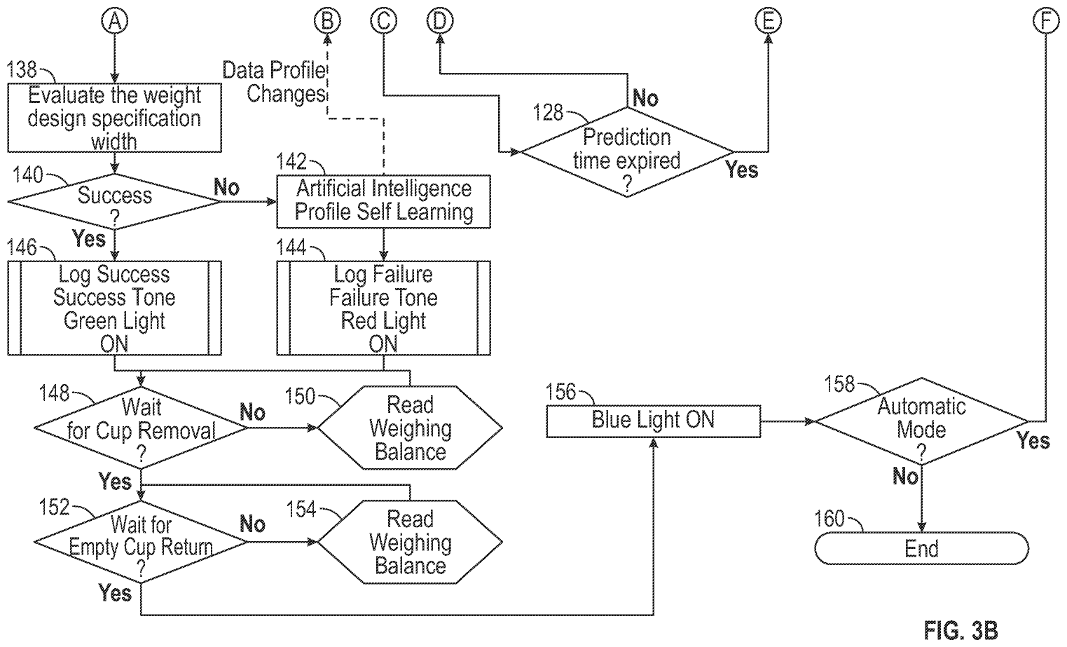

FIGS. 3A & B illustrate a method 100 of using the improved powder trickler 10 of the present invention to dispense a quantity of powder. More particularly, the method starts (102) by turning the white work light on (104). Then, the weighing balance is re-zeroed (106). The weighing balance is then checked that it is zeroed (108). If the weighing balance is not zeroed, step (106) is repeated. If the weighing balance is zeroed, the laser distance is measured (110). The measured laser distance is then used to determine if the powder cup is present (112). If the powder cup is not present, step (110) is repeated. If the powder cup is present, the weight of the powder cup is measured and compared to the target weight (114).

If the weight of the powder cup is not greater than or equal to the target weight, the artificial intelligence charge orchestrator engine is run (116). Step (116) determines if the stepper motor for bulk dispensing or the vibrating motor for fine dispensing is to be operated, the speed of operation, the operation mode, and the evaluation point weight. Step (116) also includes the controller learning in flight powder amounts and characteristics and monitors time. Bulk speed (118) and/or find speed & mode (120) are initiated. The artificial intelligence weighing balance reader is run (122). The artificial intelligence weighing balance reader uses the evaluation weight and information regarding which of steps (118) and (120) are in operation to learn powder flow rates and characteristics and predict the time to target weight. Step (122) provides the predicted time to evaluation weight to step (116) along with the mode of operation [bulk (130), fine (132), slow (134), and/or pulse (136)]. The artificial intelligence weighing balance reader also measures the weight of the powder cup (124). If the weight of the powder cup is not at the evaluation weight, step (122) is repeated. If the weight of the powder cup is at the evaluation weight, the operational motor(s) are stopped (126). Step (126) also occurs if the time measurement by the artificial intelligence charge orchestrator engine at step (128) shows the prediction time has expired. If the prediction time has not expired, step (116) is repeated.

After step (126), step (114) is repeated. If the weight of the powder cup is less than the target weight, step (116) is repeated. If the weight of the powder cup is greater than or equal to the target weight, the weight design specification width is evaluated (138). Success is then determined (140). If success has not occurred, artificial intelligence profile self learning occurs (142) with the data profile changes being passed to step (116). Then, failure is logged, the failure tone is sounded, and the red light is turned on (144). If success has occurred, success is logged, the success tone is sounded, and the green light is turned on (146). After either step (144) or step (146) is completed, the weighing balance is read (148). If the powder cup has not been removed, the weighing balance is read again (150), and step (148) is repeated. If the powder cup has been removed, the weighing balance is read (152). If the empty powder cup has not been returned, the weighing balance is read again (154), and step (152) is repeated. If the empty powder cup has returned, the blue light is turned on (156). Then, automatic mode status is determined (158). If automatic mode status is off, the method ends (160). If automatic mode status is on, step (104) is repeated.

Although the method 100 has been described and illustrated as a step-by-step flowchart, it should be appreciated that the CPU of the controller, which is located on the PCB, uses a multitasking system with some tasks, such as the artificial intelligence serial data reading of the weighing balance, time and flow monitoring, and display updates being carried out by separate simultaneous tasks.

While a current embodiment of a powder trickler has been described in detail, it should be apparent that modifications and variations thereto are possible, all of which fall within the true spirit and scope of the invention. For example, because gunpowder is available in many varieties (small rods, flakes, and balls), the first and second dispensing elements can be replaced by different tubes having different properties (different weights, dimensions, and/or surface characteristics). The first and second dispensing elements can be made easily replaceable bar of providing them with quickchange components such as snap couplings or threads. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A powder trickler comprising:
a housing;
a hopper connected to the housing and defining a reservoir;
a first dispensing element having a first inlet in communication with the reservoir and a first outlet;
a second dispensing element having a second inlet in communication with the reservoir and a second outlet;
a receptacle connected to the housing and configured to receive powder from the first outlet and from the second outlet;
a scale connected to the receptacle and operable to generate a weight value of powder in the receptacle;
a controller connected to the scale to receive a weight value and connected to the first and second dispensing elements and operable to operate the dispensing elements; and
the second dispensing element being a vibratory feeder and the first dispensing element having a feeding facility other than a vibratory feeder.

2. The powder trickler of claim 1 wherein the first dispensing element has a rotational feeding facility.

3. The powder trickler of claim 1 wherein the controller is operable to operate the first dispensing element until a weight below a selected threshold weight is detected, and consequently to stop operating the first dispensing element and continue operating the second dispensing element until the threshold weight is detected.

4. The powder trickler of claim 3 wherein the controller is operable to begin operating the second dispensing element before stopping operation of the first dispensing element.

5. The powder trickler of claim 3 wherein the controller is operable to operate the second dispensing element while operating the first dispensing element.

6. The powder trickler of claim 1 wherein the controller is operable after stopping the first dispensing element to operate the second dispensing element at a reduced vibrational intensity.

7. The powder trickier of claim 1 wherein the second dispensing element is operable at a range of feed rates.

8. The powder trickier of claim 7 wherein the second dispensing element is operable at a range of vibrational intensities.

9. The powder trickier of claim 7 wherein the second dispensing element is operable with periodic pulses of vibration with intervening periods without vibration.

10. The powder trickier of claim 9 wherein the controller receives the weight value from the scale during the intervening periods without vibration and, based on the weight value, determines if an additional pulse of vibration is required.

11. The powder trickier of claim 1 including a sensor operably connected to the controller juxtaposed with the receptacle and operable to detect a quantity of powder in the receptacle other than by weight.

12. The powder trickier of claim 11 wherein the sensor includes an optical emitter.

13. The powder trickier of claim 11 wherein the sensor includes a laser.

14. The powder trickier of claim 11 wherein the sensor is vertically above the receptacle.
